(19) United States
(12) Patent Application Publication
(10) Pub. No.: US 2001/0027427 A1
(43) Pub. Date: Oct. 4, 2001

(54) Server, internet shopping system, privilege allocation method, and recording medium upon which this method is recorded

(76) Inventor: Keiichi Minami, Tokyo (JP)

Correspondence Address: McGinn & Gibb, PLLC, Suite 200, 8321 Old Courthouse Road, Vienna, VA, 22182-3817, US

(21) Appl. No.: 09/822,348

(22) Filed: Apr. 2, 2001

(30) Foreign Application Priority Data
Apr. 4, 2000 (JP) P2000-102160

(51) Int. Cl. G06F 17/00; G06G 7/00; G06F 17/60

(52) U.S. Cl. 705/26; 705/400

(57) ABSTRACT

For a provider which provides connection services and which cooperates with a sales business, a server is proposed which allocates privileges to users who utilize these connection services. An input section receives requests from terminals of users. A decision section decides, from data which are input via the input section, whether or not a user is requesting purchase of goods by utilizing points. A point allocation section performs allocation of points to each user. A purchase information storage section stores information relating to goods etc. which have been purchased by users via internet shopping; for example, for each user, information as to where and what he has bought, its price, and the like. And a point number storage section stores, for example for each user, the number of points which have been allocated.

### BACKGROUND OF THE INVENTION

1. Field of the Invention

The present invention relates to a server possessed by a provider which, when a user purchases goods from a cooperating internet shop, invoices the user for the purchase price thereof and for the internet connection fee in the same manner; and also relates to an internet shopping system which includes this server, to a method of allocating privileges to the user, and to a recording medium upon which this method is recorded.

2. Description of the Related Art

In the prior art there have been the following types of method for settling payments for internet shopping.

(1) The user executes procedures for special settlement with a business which deals in electronic cash, and settlement between the user and the business takes place using electronic cash.

(2) The user transmits his credit card number to the sales business, and settlement takes place using this credit card.

(3) The user is connected to the internet via a connection business which is in a cooperative relationship with the sales business, and settles the purchase price together with the payment of his connection fee.

Although the three methods described above as examples are available, they are subject to the following disadvantages. Namely, when settlement is performed according to method (1), the user is obliged to undertake troublesome procedures for settling with the sales business using electronic cash. Further, when settlement is performed according to method (2), the user is obliged to transmit the number of his own credit card via the internet, and a problem arises with regard to security. Moreover, when the user has contracted with a connection business which cooperates with the sales business, and settlement is performed according to method (3), the sum to be paid to the connection business becomes equal to the connection fee plus the purchase price for the goods, and the problem has arisen that, even though the user's choice in selection of the connection business has become narrower, the user does not experience any feeling of getting a good bargain.

The present invention has been made in consideration of the above identified problems, and its objective is to propose a server which is provided to a connection business which has established cooperation with a sales business, and which, when a user employs this connection business, makes an allocation of privileges to that user.

Further, another objective of the present invention is to propose an internet shopping system which can perform internet shopping with privileges which have been allocated to users.

Yet further, another objective of the present invention is to propose a method of allocating privileges to users, and a storage medium upon which is recorded a program related to this method.

### SUMMARY OF THE INVENTION

In order to achieve the above identified objectives, the present invention proposes a server provided to a provider which, when goods are to be purchased from an internet shop, performs calculation of the purchase price, comprising a point allocation device which allocates to each user points corresponding to usage of said provider; and a point number storage device which stores for each user the number of said points which have been allocated by said point allocation device.

Since according to the above described structure, when the user employs said provider, points according to his usage are allocated by the point allocation device, accordingly, if the provider accords privileges according to these points, the user is empowered to receive these privileges according to the usage which he has made of the provider.

Furthermore, according to another aspect of the present invention, in order to achieve the above identified objectives, the present invention proposes a server of the type identified above, wherein, when a user purchases goods from said internet shop, said point allocation device subtracts a number of points corresponding to the purchase price from the number of points for said user which is stored in said point number storage device, and performs procedures for paying said purchase price to said cooperating internet shop.

Since according to the above described structure, when the user purchases goods from the specified internet shop, the point allocation device subtracts a number of points corresponding to the purchase price from the number of points for said user which is stored in the point number storage device, and pays the purchase price for the goods to the internet shop, thereby the user is empowered to receive privileges according to the usage which he has made of the provider.

Furthermore, since the user is enabled to perform internet shopping simply and moreover safely, the user will frequently perform internet shopping, and due to this the volume of orders for a sales business provided by internet shopping can be increased.

Yet further, since the user is able to purchase goods with the points which he has accumulated, it is possible for internet shopping to provide to the user the feeling of getting a good bargain.

The provider can allocate points to the user instead of reducing the fee for connecting him to the internet.

Moreover, since when the user switches to another provider it becomes impossible for him to utilize his points, accordingly it becomes difficult for him to switch to another provider, and therefore the benefit accrues to the provider of stable revenue being easily available.

Furthermore, according to another aspect of the present invention, in order to achieve the above identified objectives, the present invention proposes a server as described above, wherein, if the result of subtracting said number of points corresponding to said purchase price from said number of points for said user which is stored in said point number storage device is a negative amount of points, said point allocation device performs processing for invoicing said user for a sum which corresponds to the magnitude of said negative amount of points, and sets said number of points for said user which is stored in said point number storage device to zero.

By the provision of the above described structure, if the number of points which the user has is insufficient for the goods which he wants to purchase, only the cost for the amount of points by which the user falls short is imposed upon him, and therefore he can use his points efficiently.

Furthermore, according to another aspect of the present invention, in order to achieve the above identified objectives, the present invention proposes a server as described above, wherein, when a user discontinues his contract with said provider, said point allocation device, upon the instigation of said user, adds said number of points for said user which is stored in said point number storage device to the number of points for another user which is stored in said point number storage device.

Since according to the above described structure the user is enabled to transfer his points to another user if he discontinues his internet connection contract with the provider, therefore he is not constrained to waste his points in this eventuality.

Furthermore, according to another aspect of the present invention, in order to achieve the above identified objectives, the present invention proposes a server as described above, wherein, when a user concludes a new connection contract with said provider, said point allocation device allocates a predetermined number of points to said user.

According to yet another aspect of the present invention, in order to achieve the above identified objectives, the present invention proposes an internet shopping system, comprising a server as described above, and a server upon which is stored said internet shop which performs the sale of goods according to the points which are stored by said server.

Furthermore, according to a method aspect of the present invention, in order to achieve the above identified objectives, the present invention proposes a privilege allocation method implemented upon a server which is provided to a provider which, when goods are to be purchased from an internet shop, performs calculation of the purchase price, comprising: performance of a procedure for allocation to each user of points corresponding to usage of said provider; and performance of a procedure for storage for each user of the number of said points which have been allocated according to said point allocation procedure.

Furthermore, according to another method aspect of the present invention, in order to achieve the above identified objectives, the present invention proposes a privilege allocation method as described above, further comprising, when a user purchases goods from said internet shop: performance of a procedure for subtraction of a number of points corresponding to the purchase price from the number of points for said user which is stored, and performance of a procedure for paying said purchase price to said cooperating internet shop.

And, according to yet another method aspect of the present invention, in order to achieve the above identified objectives, the present invention proposes a privilege allocation method as described above, further comprising a procedure for, if the result of said procedures for subtracting said number of points corresponding to said purchase price from said number of points for said user which is stored is a negative amount of points, invoicing said user for a sum which corresponds to the magnitude of said negative amount of points, and a procedure for then setting said stored number of points for said user to zero.

And, according to a recording medium aspect of the present invention, in order to achieve the above identified objectives, the present invention proposes a recording medium, for a server which is provided to a provider which, when goods are to be purchased from an internet shop, performs calculation of the purchase price, which can be read by a computer, and on which is stored a program which causes said computer to execute a function of allocating to each user points corresponding to usage of said provider; and a function of storing for each user the number of said points which have been allocated by said point allocation function.

And, according to another recording medium aspect of the present invention, in order to achieve the above identified objectives, the present invention proposes a recording medium as described above, wherein said program further causes said computer to execute a function of, when a user purchases goods from said internet shop, subtracting a number of points corresponding to the purchase price from the number of points for said user which is stored, and a function of performing procedures for paying said purchase price to said cooperating internet shop.

And, according to yet another recording medium aspect of the present invention, in order to achieve the above identified objectives, the present invention proposes a recording medium as described above, wherein said program further causes said computer to execute a function of, if the result of subtracting said number of points corresponding to said purchase price from said number of points for said user which is stored is a negative amount of points, performing processing for invoicing said user for a sum which corresponds to the magnitude of said negative amount of points, and a function of then setting said number of points for said user to zero.

It should be understood that it would also be acceptable for a program for implementing the functions of the point server 111 shown in FIGS. 5 through 10 to be recorded upon a recording medium which can be read by a computer, and for privilege allocation to be performed by this program being read into a computer system and being executed thereby. Moreover, the term “computer system” is here to be understood as including an OS and hardware such as peripheral devices and the like. Further, if the www-system is taken advantage of, “computer system” should also be understood as including an environment offered by a home page (or a display environment). Further, by “recording medium which can be read by a computer”, there is meant a portable medium such as a floppy disk, an opto-magnetic disk, a ROM, a CD-ROM or the like, or a storage device internal to a computer system such as a hard disk or the like. Yet further, this term “recording medium which can be read by a computer”, is also intended to include a device which maintains the program for a certain time period, such as a volatile memory (RAM) internal to a computer system which operates as a server or a client when the program is transmitted via a network such as the internet or the like, or via a communication line such as a telephone line or the like.

Further, it would also be acceptable for the above described program to be transmitted from a computer system which stores this program in a storage device or the like to another computer system via a transmission medium, or by a transmission wave within a transmission medium. Here, the term “transmission medium” which transmits the program device a medium which is endowed with the function of transmitting information, such as a network (communication net) such as the internet or the like, or a communication line (communication channel) such as a telephone line or the like. Further, it would also be acceptable for the above described program to be one for implementing a portion of the above described functions. Yet further, a so called differential file (differential program) which is able to implement the above described function in combination with a program which is already recorded in the computer system, would also be acceptable.

### BRIEF DESCRIPTION OF THE DRAWINGS

FIG. 1 is a block diagram showing the structure of a network including a provider to which a server according to an embodiment of the present invention is provided;

FIG. 2 is a block diagram showing the structure of this server according to the embodiment;

FIG. 3 is a figure showing an example of data which is stored in a purchase information storage section 204;

FIG. 4 is a figure showing an example of data which is stored in a point number storage section 205;

FIG. 5 is a flow chart for explanation of the flow of the operation of a point server 111 after a user has terminated internet access via a provider 102;

FIG. 6 is a flow chart showing the process flow of the point server 111 for the day (the fee collection day) when the provider 102 collects a connection fee to the internet 104 from the user;

FIG. 7 is a flow chart showing the process flow of the point server 111 when the user cooperates with the provider 102 to purchase an item of goods from an internet shop;

FIG. 8 is a screen for performing verification of a purchase and selection of the method for payment of the price thereof;

FIG. 9 is a flow chart showing the process flow when the user discontinues his contract with the provider 102; and:

FIG. 10 is a screen for use when one user transfers his own points to another.

### DETAILED DESCRIPTION OF THE PREFERRED EMBODIMENT

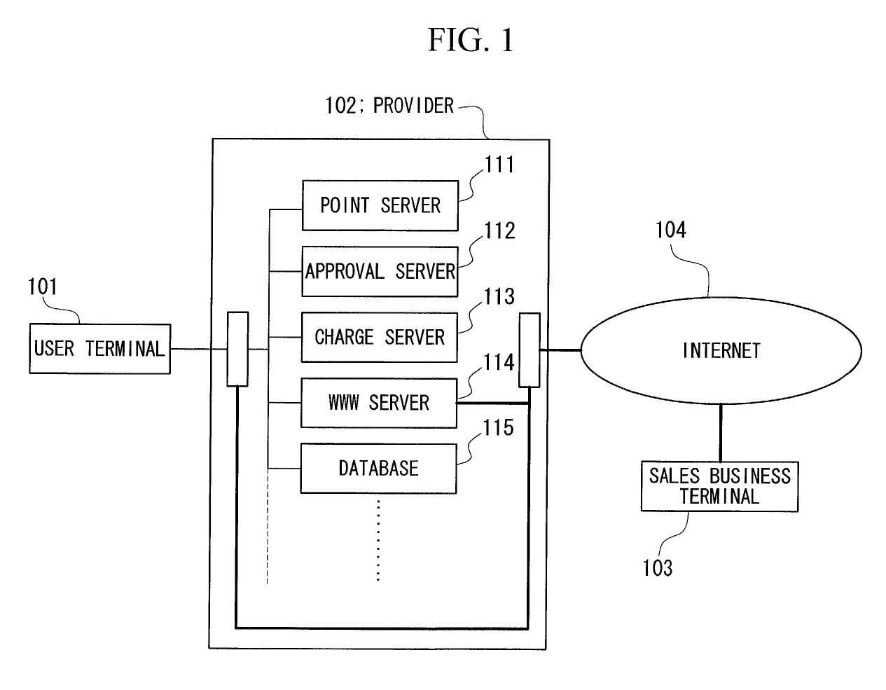

Next, an embodiment of the present invention will be explained in detail with reference to the figures. FIG. 1 is a block diagram showing the relationships between a connection business (hereinafter termed the “provider”) 102 by whom a server according to an embodiment of the present invention is provided, the terminal 101 of a user who has established a contract with this provider 102, and the terminal 103 of a sales business which sells goods upon the internet 104. As shown in FIG. 1, the provider 102 comprises a point server 111, an approval server 112, a charge server 113, a WWW server 114, a database 115, and the like.

Here, the point server 111 is a server according to an embodiment of the present invention, and is a server which allocates points to a user (hereinafter simply termed the “user”) who has an internet connection contract with the provider 102 according to the amount of connection time and the like. This point server 111 will be explained in detail hereinafter.

Further, the approval server 112 decides, when a user accesses the provider 102, whether or not he has an internet connection contract with the provider 102. The charge server 113 debits the user for the connection fee and the like. The WWW server 114 searches out sites which the user requests from the internet 104 and transmits these searched out sites to the user. And the database server 115 stores information relating to the user.

In this embodiment, a user who has been allocated points by the provider is able to use these points to purchase goods from sales businesses which sell goods on the internet 104 (in the following simply termed “sales businesses”).

A sales business performs sale of goods to a user who has an internet connection contract with the provider 102 by taking advantage of points which have been allocated. The provider transfers the purchase price of the goods for the user to the sales business according to the points which have been given to the user.

It should be understood that the user, when establishing an internet connection contract with the provider 102, is able to select between various charging formulas for paying for his connection time, such as a base charge contract, a time proportional charge contract, a base charge+time proportional charge contract, and the like.

Here, by a base charge contract is meant a contract according to which, upon payment of a fixed base charge (the fixed contract charge) each month or each year as a connection fee to the internet 104, the user may connect to the internet 104 for any length of time.

Further, by a time proportional charge contract is meant a contract according to which, each month or each year, the user must make a basic payment and also a further payment according to the amount of his connection time to the internet 104. It should be noted that, although in this embodiment it is stipulated that in the case of a time proportional contract it is necessary to pay a basic payment, it would also be acceptable, as an alternative, for there to be no such basic payment.

Yet further, by a base charge+time proportional charge contract is meant a contract according to which, upon payment of a fixed base charge (the fixed contract charge) each month or each year as a connection fee to the internet 104, the user may connect to the internet 104 for a certain predetermined length of time only, and, if this predetermined time period has been exceeded, he must make a further payment according to the amount by which his connection time to the internet 104 has exceeded this predetermined time period.

For each user, the details of this user's internet connection contract are stored together with his user information such as his user ID, name, address, account number and the like in the database 115.

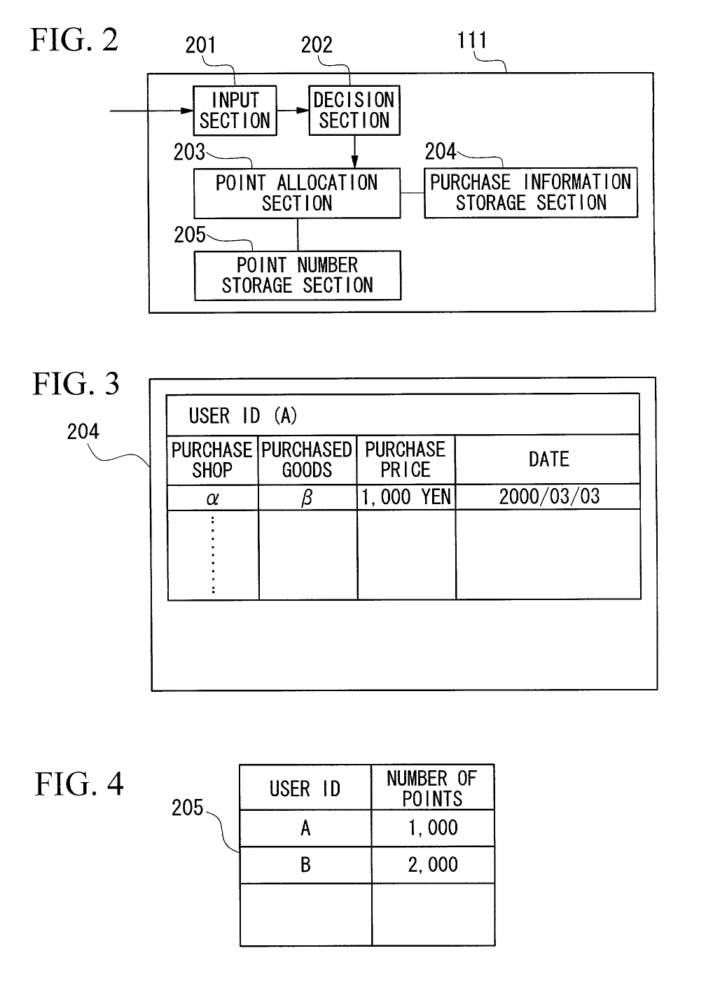

FIG. 2 is a block diagram showing the structure of the point server 111. In this figure, the reference numeral 201 denotes an input section which receives requests from devices such as other server terminals and the like. The reference numeral 202 denotes a decision section which decides, from the input data which has been input via the input section 201, whether or not a user is requesting to purchase goods using his points.

And the reference numeral 203 denotes a point allocation section which performs allocation of points to the user.

The reference numeral 204 denotes a purchase information storage section which stores information relating to goods which the user has purchased by internet shopping, and the like. The information stored in this purchase information storage section 204 may for example, as shown in FIG. 3, be information for each user relating to his goods purchasing history, such as when, where, what, and for how much he has purchased, and the like.

The reference numeral 205 denotes a point number storage section which stores, for each user, the number of points which this user possesses, for example as shown in FIG. 4.

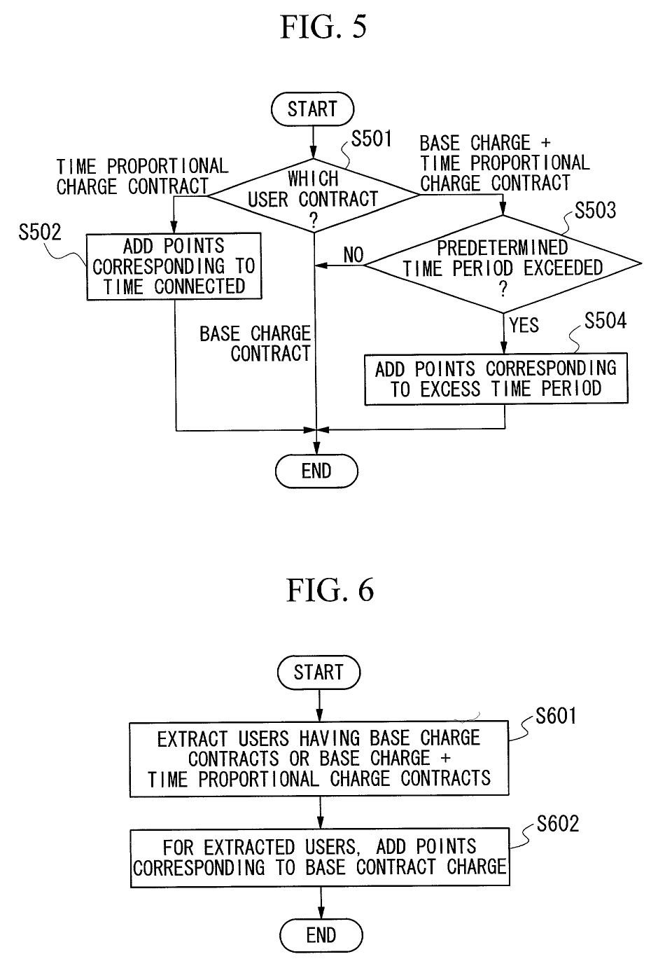

The operation of this point server shown in FIG. 2 will now be explained in detail with reference to FIGS. 5 through 10.

FIG. 5 is a flow chart for explanation of the flow of the operation of the point server 111 for allocating points to a user, after the user has terminated internet access via the provider 102.

When the point allocation section 203 of the point server 111 receives notification from a device provided to the provider 102 that a user A has terminated access to the provider 102 and notification of his access time, it searches through the database 115, and determines (in the step S501) whether the contract for this user A is a base charge contract, a time proportional charge contract, or a base charge+time proportional charge contract.

If the result of the step S501 is that the contract for this user is a base charge contract, then the operation of this point allocation section 203 terminates. Moreover, if the result of the step S501 is that the contract for this user is a time proportional charge contract, then the point allocation section 203 adds (in the step S502), to the number of points for this user stored in the point number storage section 205, a number of points which corresponds to the length of time that this user has been connected to the internet 104 this time. It should be understood that, in order thus to determine the number of points which corresponds to the length of time connected, the point allocation section 203 is provided with a conversion equation or a conversion table for converting connection time to number of points. It is thus possible freely to determine the relationship between the connection time and the number of points obtained by setting this conversion equation or conversion table appropriately.

On the other hand, if the result of the step S501 is that the contract for this user is a base charge+time proportional charge contract, then the point server 111 searches in the database 115 and determines (in the step S503) whether or not this user A has exceeded his predetermined time period for connection time to the internet 104.

If as the result of a YES decision in the step S503 it is determined that this user has exceeded his predetermined time period, then the point allocation section 203 adds (in the step S504) to the point number for the user A which is stored in the point number storage section 205, a number of points which corresponds to the excess time period. The calculation of this number of points is performed in a manner identical to that of the step S502. If, on the other hand, as the result of a NO decision in the step S503 it is determined that this user has not exceeded his predetermined time period, then the operation of this point server 111 terminates.

By doing this, a user who has a time proportional charge contract or a base charge+time proportional charge contract with the provider 102 can receive a number of points determined according to the length of time he has been connected to the internet 104.

FIG. 6 is a flow chart showing the process flow of the point server 111 when allocating points to the users who have base charge contracts or base charge+time proportional charge contracts with the provider 102.

When the point allocation day (for example, the day for settlement of the connection fee) arrives, the point server 111 searches in the database 115, and (in the step S601) extracts those users who have either base charge contracts or base charge+time proportional charge contracts.

After the extraction of such users has been completed, the point allocation section 203 adds (in the step S602) to the point numbers for the users who have been extracted which are stored in the point number storage section 205, the appropriate number of points which corresponds to the base contract charge.

It should be understood that, in order thus to determine the number of points which corresponds to the base contract charge, the point allocation section 203 is provided with a conversion equation or a conversion table for converting the base contract charge to the number of points. It is possible freely to determine the relationship between the base contract charge and the number of points obtained by setting this conversion equation or conversion table appropriately.

By doing this, a user who has a base charge contract or a base charge+time proportional charge contract with the provider 102 can receive a number of points determined according to the base contract charge.

It should be understood that the system for allocation of points is not to be considered as being limited to the one described above. For example, it would also be possible to arrange to give a further allocation of points to a new user who has just concluded a new connection contract with the provider 102.

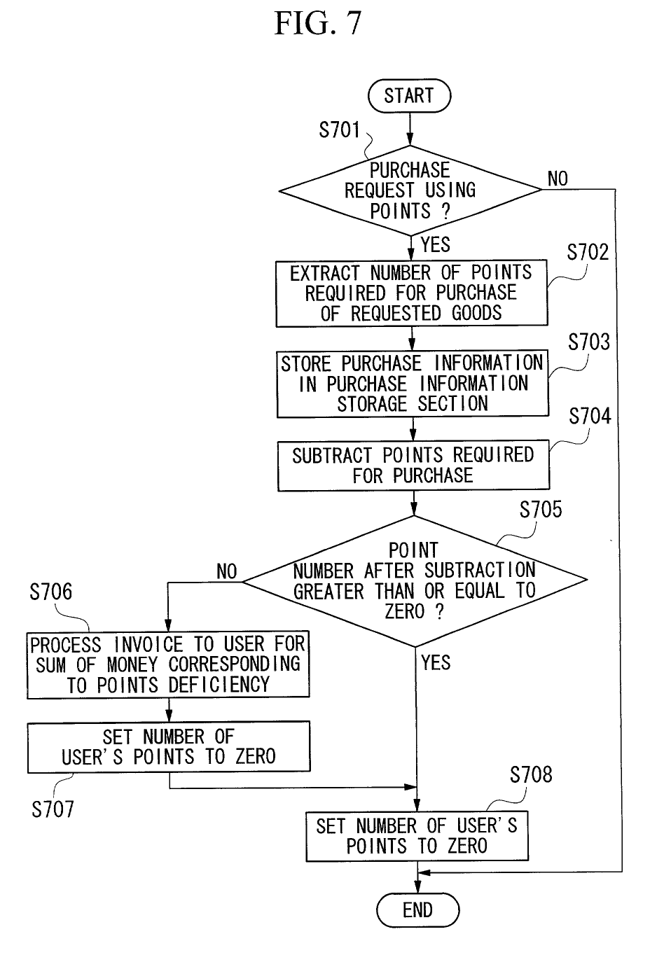

FIG. 7 is a flow chart showing the process flow of the point server 111 when the user cooperates with the provider 102 to purchase an item of goods from an internet shop. For this embodiment, the explanation will be made, by way of example, in terms of the case when the internet shop is a branch store upon the WWW server 114 which belongs to the provider 102.

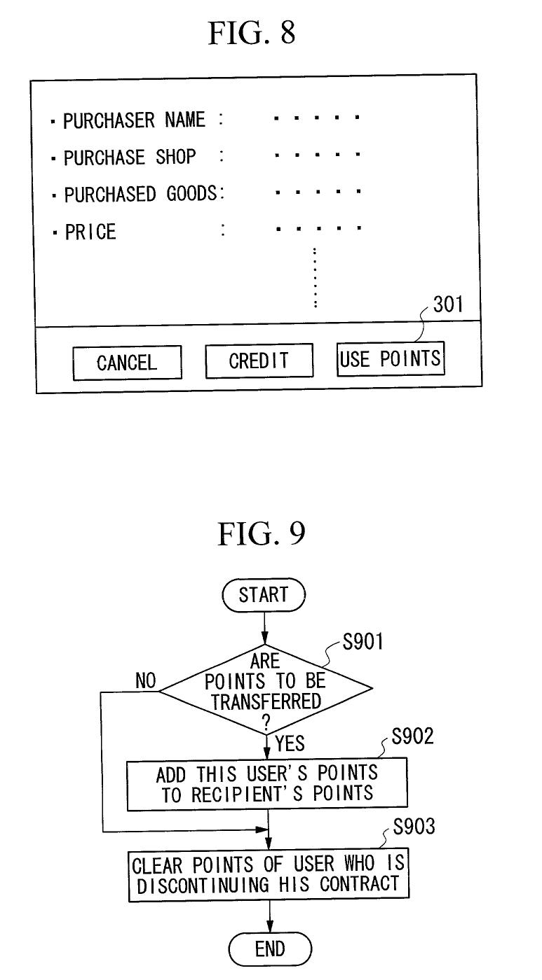

When the user A selects goods for purchase from an internet shop, the WWW server 114 sends display data to the terminal of the user, which receives this display data and displays a screen such as the one shown in FIG. 8. By doing this, the user A performs verification of the purchase and selection of a method of payment for the price thereof. Here if, for the method of payment, the user clicks upon the button 301 for using his points, then information relating to this purchaser and information relating to the goods being purchased such as the shop from which the purchase is being made, the details of the goods which are being purchased, their price, and the like is transmitted from the WWW server 114 to the point server 111.

The decision section 202 of the point server 111 determines (in the step S701) from the data which has been input via the input section 201 whether or not the method of purchase which the user A has selected consists of purchase by the use of his points.

If it is the case that the method of purchase which the user A has selected is not the use of his points (a NO decision in the step S701), then the operation of the point server 111 terminates. If on the other hand it is the case that the method of purchase which the user A has selected is the use of his points (a YES decision in the step S701), then the point allocation section 203 extracts (in the step S702) the number of points which are required for the purchase of the goods which the user A has selected. Further, it stores (in the step S703) in the purchase information storage section 204 information relating to the purchase, such as the user who is making the purchase, the shop from which the purchase is being made, the price of the purchase, and the like.

Next, the point allocation section 203 subtracts (in the step S704) the number of points which was calculated in the step S702 from the number of points for this user which is stored in the point number storage section 205.

When the adjustment of the number of points has been completed, the point allocation section 203 checks (in the step S705) whether or not the number of points for this user A which is stored in the point number storage section 205 is still greater than or equal to zero.

In the event of a YES result in the step S705, the point server 111 performs payment processing (in the step S708) for the purchase price to the shop from which the purchase has been made. On the other hand, in the event of a NO result in the step S705, the point server 111 notifies the charge server 113 of a sum of money which corresponds to the amount by which the number of points has fallen short. According to this, the charge server 113 performs (in the step S706) invoice processing to the user of this sum of money which corresponds to the amount by which the number of points has fallen short.

When this invoice processing in the step S706 has been completed, the point allocation section 203 sets (in the step S707) the number of points for the user A which is stored in the point number storage section 205 to zero.

By doing this, the user is able to perform internet shopping by using his points.

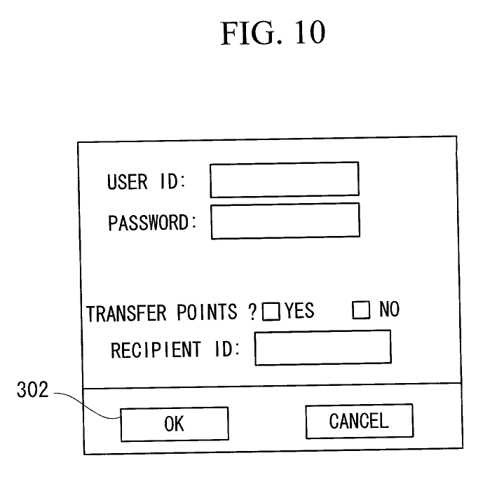

FIG. 9 is a flow chart showing the process flow when a user discontinues his contract with the provider 102. Here, as shown in FIG. 10, a home page is provided upon the WWW server 114 for discontinuing the user's internet connection contract, and the user performs processing via this home page in order to discontinue his internet connection contract.

When the user has set the required items upon the screen shown in FIG. 10 for discontinuing his internet connection contract and presses the OK button 302, the WWW server 114 refers to the approval server 112 and checks whether or not the user ID and password which have been set are correct. If they are correct, then the WWW server transmits to the point server 111 the user ID and information as to whether the points for this user are to be transferred or not, and, if point transfer is to take place, also transfers to the point server 111 the ID of the person to whom this user's points are to be transferred (which is a user ID for which a contract with the provider 102 is in force). The point server 111 decides (in the step S901) whether or not the points which are being stored for this user are to be transferred to anyone, using this information which has been received.

If in the step S901 it is determined that a transfer of this user A's points is to be performed, then the point allocation section 203 adds (in the step S902) the number of points which this user A currently possesses to the number of points stored in the point number storage section 205 for the recipient user to whom this transfer is to be performed. On the other hand if in the step S901 it is determined that no transfer of this user A's points is to be performed, and also when the processing in the step S902 has been completed, then the point allocation section 203 clears the number of points for the user A which is stored in the point number storage section 205. By doing this, it is possible to transfer the points which are possessed by a user who discontinues his connection contract with the provider 102 to another user.

Since as explained above, according to the present invention, a server is provided to a provider which, when goods are to be purchased from an internet shop, performs calculation of their purchase price, and this server comprises a point allocation device which allocates to each user points corresponding to usage of said provider, and a point number storage device which stores for each user the number of said points which have been allocated by said point allocation device, accordingly, if the provider accords privileges according to these points, the user is empowered to receive privileges according to his usage of the provider.

Although the present invention has been described in detail in the above with reference to a preferred embodiment thereof and with reference to the drawings, the present invention is not to be considered as being limited merely to the above described embodiment; the present invention also of course is to be understood as including various alterations and changes of the details thereof, provided that there is no deviation from the gist of the present invention.

What is claimed is:

1. A server provided to a provider which, when goods are to be purchased from an internet shop, performs calculation of the purchase price, comprising:
a point allocation device which allocates to each user points corresponding to usage of said provider; and:
a point number storage device which stores for each user the number of said points which have been allocated by said point allocation device.

2. A server according to claim 1, wherein, when a user purchases goods from said internet shop, said point allocation device subtracts a number of points corresponding to the purchase price from the number of points for said user which is stored in said point number storage device, and performs procedures for paying said purchase price to said cooperating internet shop.

3. A server according to claim 2, wherein, if the result of subtracting said number of points corresponding to said purchase price from said number of points for said user which is stored in said point number storage device is a negative amount of points, said point allocation device performs processing for invoicing said user for a sum which corresponds to the magnitude of said negative amount of points, and sets said number of points for said user which is stored in said point number storage device to zero.

4. A server according to claim 1, wherein, when a user discontinues his contract with said provider, said point allocation device, upon the instigation of said user, adds said number of points for said user which is stored in said point number storage device to the number of points for another user which is stored in said point number storage device.

5. A server according to claim 1, wherein, when a user concludes a new connection contract with said provider, said point allocation device allocates a predetermined number of points to said user.

6. An internet shopping system, comprising a server according to claim 2, and a server upon which is stored said internet shop which performs the sale of goods according to the points which are stored by said server.

7. A privilege allocation method implemented upon a server which is provided to a provider which, when goods are to be purchased from an internet shop, performs calculation of the purchase price, comprising:
performance of a procedure for allocation to each user of points corresponding to usage of said provider; and:
performance of a procedure for storage for each user of the number of said points which have been allocated according to said point allocation procedure.

8. A privilege allocation method according to claim 7, further comprising, when a user purchases goods from said internet shop:
performance of a procedure for subtraction of a number of points corresponding to the purchase price from the number of points for said user which is stored, and:
performance of a procedure for paying said purchase price to said cooperating internet shop.

9. A privilege allocation method according to claim 8, further comprising a procedure for, if the result of said procedures for subtracting said number of points corresponding to said purchase price from said number of points for said user which is stored is a negative amount of points, invoicing said user for a sum which corresponds to the magnitude of said negative amount of points, and a procedure for then setting said stored number of points for said user to zero.

10. A recording medium, for a server which is provided to a provider which, when goods are to be purchased from an internet shop, performs calculation of the purchase price, which can be read by a computer, and on which is stored a program which causes said computer to execute:
a function of allocating to each user points corresponding to usage of said provider; and:
a function of storing for each user the number of said points which have been allocated by said point allocation function.

11. A recording medium according to claim 10, wherein said program further causes said computer to execute a function of, when a user purchases goods from said internet shop, subtracting a number of points corresponding to the purchase price from the number of points for said user which is stored, and a function of performing procedures for paying said purchase price to said cooperating internet shop.

12. A recording medium according to claim 11, wherein said program further causes said computer to execute a function of, if the result of subtracting said number of points corresponding to said purchase price from said number of points for said user which is stored is a negative amount of points, performing processing for invoicing said user for a sum which corresponds to the magnitude of said negative amount of points, and a function of then setting said number of points for said user to zero.
